(19) United States
(12) Patent Application Publication
(10) Pub. No.: US 2007/0155448 A1
(43) Pub. Date: Jul. 5, 2007

(54) Sliding mechanism of handheld electronic device

(76) Inventor: Jia-Sing Hong, Taipei (TW)

Correspondence Address: LEONG C LEI, PMB # 1008, 1867 YGNACIO VALLEY ROAD, WALNUT CREEK, CA, 94598, US

(21) Appl. No.: 11/324,308

(22) Filed: Jan. 4, 2006

(51) Int. Cl. H04M 1/00

(52) U.S. Cl. 455/575.4

(57) ABSTRACT

A novel sliding mechanism for a handheld electronic device is provided, which contains a first member fixedly jointed to a first part of the handset, a second member fixedly jointed to a second part of the handset, and a pair of resilient elements having their two ends attached to the appropriate locations on the inner surfaces of the first and second members respectively. During the sliding movement of the first and second members, the first and second resilient elements are always compressed first to store energy and then expand automatically as the stored energy is released.

### BACKGROUND OF THE INVENTION

(a) Technical Field of the Invention

The present invention generally relates to handheld electronic devices containing two parts capable of relative sliding movement, and more particularly to the sliding mechanism of a handheld electronic device allowing the two parts to be automatically slid apart or together.

(b) Description of the Prior Art

The sliding mechanism currently adopted by a conventional sliding handset normally contains a first member and a second member fixedly jointed to, for example, the cover and the body of the sliding handset, respectively. The two members are interfaced physically such that they are capable of sliding movement relative to each other along their interface between an open position and a closed position. Usually, when the two members are slid to one of these two positions, a corresponding operation of the handset would be automatically triggered. For instance, when the cover and the body are slid apart into the open position, the handset is off-hooked (e.g., to pick up an incoming call) and, when the cover and the body are slid together into the closed position, the handset is on-hooked (e.g., to hang up the call).

With the current sliding mechanism, a user of the sliding handset has to exert force to slide the cover or the body all the way from the closed position to the open position until they are held at the open position by the sliding mechanism. Similarly, to restore the cover and the body from their open position to the closed position, the user has to exert force all the way until the cover and the body are held together at the closed position.

### SUMMARY OF T INVENTION

The primary purpose of the present invention is to provides a novel sliding mechanism to obviate the shortcomings of the current approaches. The sliding mechanism contains a first member fixedly jointed to a first part of the handset, and a second member fixedly jointed to a second part of the handset. The first and second members are slide-joined together so that they, as well as the first and second parts of the handset, are capable of sliding movement along their joining interface relative to each other.

The sliding mechanism further contains a first resilient element and a second resilient element, each of which is a spring wire wound into a curved segment having multiple consecutive and coplanar loops along the length of the segment. The resilient elements have their two ends attached to the appropriate locations on the inner surfaces of the first and second members respectively. The resilient elements are configured such that the first and second resilient elements do not cross or overlap each other during the sliding movement of the first and second members. Further, during the sliding movement of the first and second members between the closed and open positions, the first and second resilient elements are always compressed first to store energy and then expand automatically as the stored energy is released.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective exploded view showing the various components of the sliding mechanism according to an embodiment of the present invention.

FIG. 2 is a front view showing the sliding mechanism of FIG. 1 in the closed position.

FIG. 3 is a front view showing the sliding mechanism of FIG. 1 in the transition from the closed position to the open position.

FIG. 4 is a front view showing the sliding mechanism of FIG. 1 in the open position.

FIG. 5 is a front view showing the sliding mechanism of FIG. 1 in the transition from the open position to the closed position.

FIG. 6 is a front view showing the sliding mechanism of FIG. 1 in the closed position.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

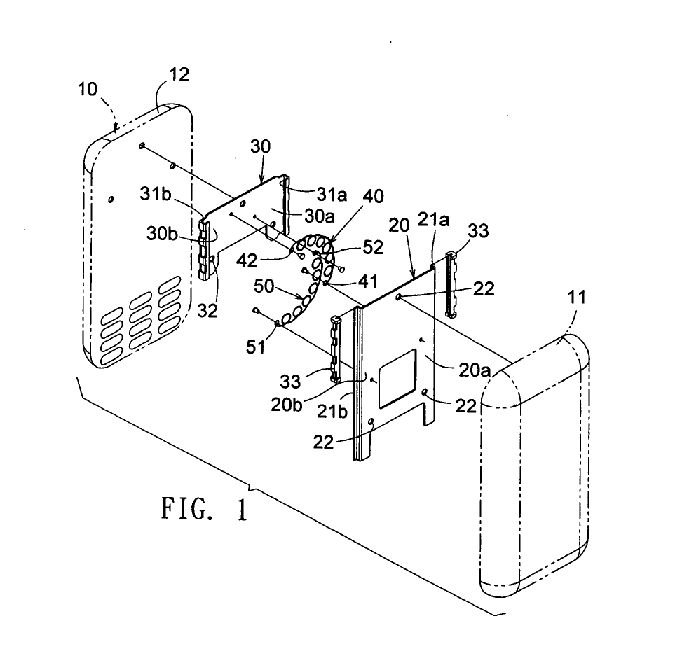

Please refer to FIGS. 1 to 6. As illustrated, an embodiment of the present invention mainly contains a plate-like first member 20, a plate-like second member 30, a first resilient element 40, and a second resilient element 50. The sliding mechanism is applied to a handheld electronic device 10 (such as a mobile handset, a PDA, or a similar device) which contains a first part 11 (e.g., the cover of the mobile handset) and a second part 12 (e.g., the body of the mobile handset). The first and second members 20 and 30 are fixedly joined to the first and second parts 11 and 12 of the handheld electronic device 10, respectively. The first and second members 20 and 30 are slide-joined together so that they, as well as the first and second parts 11 and 12 of the device 10, are capable of sliding movement along their joining interface relative to each other between an open position where the two members 20 and 30 are farthest apart and a closed position where the two members 20 and 30 are closest together. The first resilient element 40 has its one end 41 fixedly attached to a location within the area 20a on the inner surface of the first member 20. On the other hand, the first resilient element 40 has the other end 42 fixedly attached to a location within the area 30b on the inner surface of the second member 30. Similarly, the second resilient element 50 has its two ends 51 and 52 fixedly attached to locations within the areas 20b and 30a on the inner surfaces of the first and second members 20 and 30, respectively. Please note that the inner surfaces of the two members 20 and 30 are the two opposing surfaces of the members 20 and 30 that interface with each other. The present invention relies on the two resilient elements 40 and 50 to provide automatic sliding movement back and forth between the open and closed positions of the device 10.

As shown in FIG. 1, the two vertical edges 21a and 21b of the first member 20 are bended inward toward its inner surface to form ‘]’ and‘[’ shapes. Similarly, the two vertical edges 31a and 31b of the second member 30 are also bended inward toward its inner surface to form ‘[’ and ‘]’ shapes. The vertical edges 21a, 21b, 31a, and 31b are configured such that the vertical edges 31a and 31b are wrapped inside the troughs formed by the vertical edges 21a and 21b, and the first and second members 20 and 30 are thereby capable to slide relative to each other.

As also shown in FIG. 1, a pad element 33 made of a material having low friction coefficient is configured along each of the vertical edges 31a and 31b so that the relatively sliding movement of the first and second members 20 and 30 are further smoothed.

Each of the resilient elements 40 and 50 is a spring wire wound into a curved segment having multiple consecutive and coplanar loops along the length of the segment. The loops are for the absorption and storage of mechanical energy. Also, as the resilient elements 40 and 50 are compressed during the sliding movement of the first and second member 20 and 30, the pressure is distributed to and sustained by the loops so that the resilient elements 40 and 50 wouldn't be broken easily after a period of usage.

As illustrated, the two ends 41 and 42 of the first resilient element 40 and the two ends 51 and 52 of the second resilient element 50 are screw-joined to the inner surfaces of the two members 20 and 30. However, this method of attachment is only exemplary and the present invention does not require the resilient elements to be installed in a specific manner.

The first member 20 has a number of through holes 22 for screw-joining the first member 20 to the first part 11 of the handheld electronic device 10. The first member 20 can also be an integral part of the housing of the first part 11 when the housing is molded. The present invention does not require the first member 20 to be formed or joined to the first part 11 by any specific means.

The second member 30 has a number of through holes 32 for screw-joining the second member 30 to the second part 12 of the handheld electronic device 10. The second member 30 can also be an integral part of the housing of the second part 12 when the housing is molded. The present invention does not require the second member 30 to be formed or joined to the second part 12 by any specific means.

The most important characteristic of the present invention lies in the use of the first and second resilient elements 40 and 50 configured between the first and second members 20 and 30. Please note that the locations of their two ends on the inner surfaces of the first and second members 20 and 30 shown in the accompanied drawings are exemplary only. There are various other ways to arrange the first and second resilient elements 40 and 50. However, they are configured such that the first and second resilient elements 40 and 50 do not cross or overlap each other during the sliding movement of the first and second members 20 and 30. Further, during the sliding movement of the first and second members 20 and 30 between the closed and open positions, the first and second resilient elements 40 and 50 are always compressed first to store energy and then expand automatically as the stored energy is released.

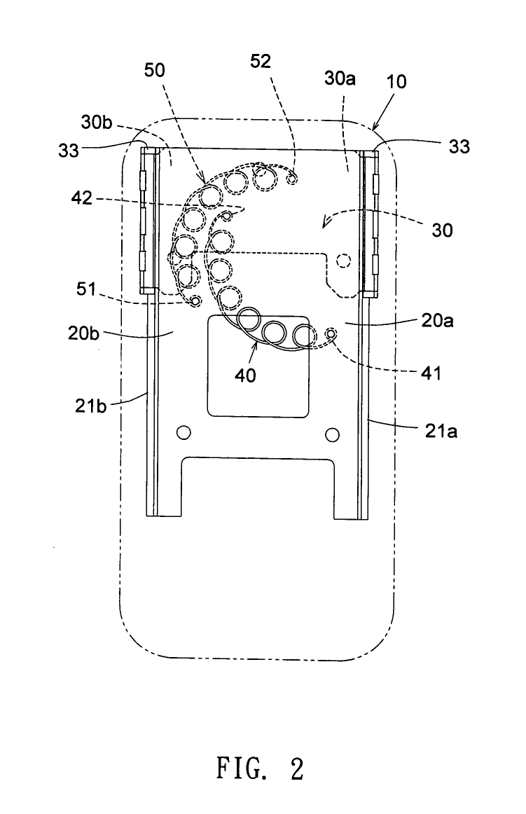

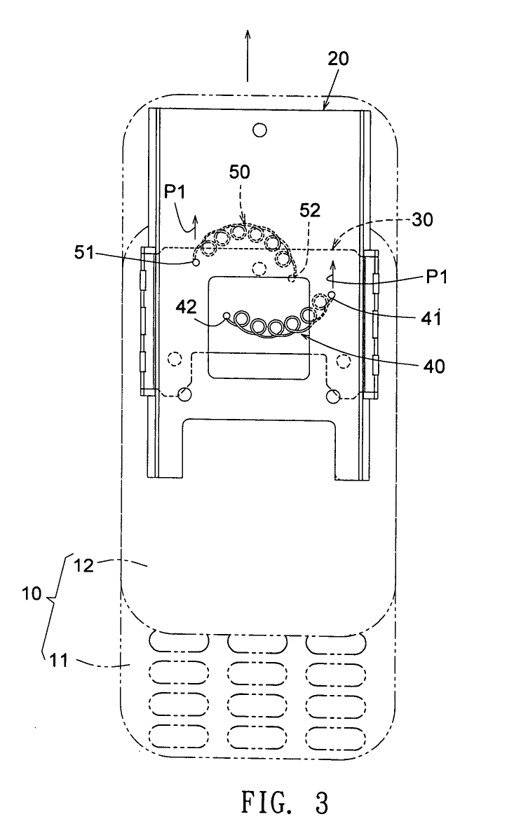

FIG. 2 is a front view showing the sliding mechanism of FIG. 1 in the closed position. When the first part 11 of the handheld electronic device 10 is slid apart from the second part 12, mechanical energy is stored as the first and second resilient elements 40 and 50 are compressed simultaneously. When the relative locations of the first and second parts 11 and 12 reach what are shown in FIG. 3, the ends 41 and 51 of the first and second resilient elements 40 and 50 attached to the first member 20 are about to pass beyond the ends 42 and 52 attached to the second member 30, respectively. If the first and second members 20 and 30 are farther apart, the first and second resilient elements 40 and 50 begin to expand and the stored energy is released. As such, from this point on, the first and second members 20 and 30 are automatically slid to the open position entirely by the resilient elements 40 and 50 without any external force.

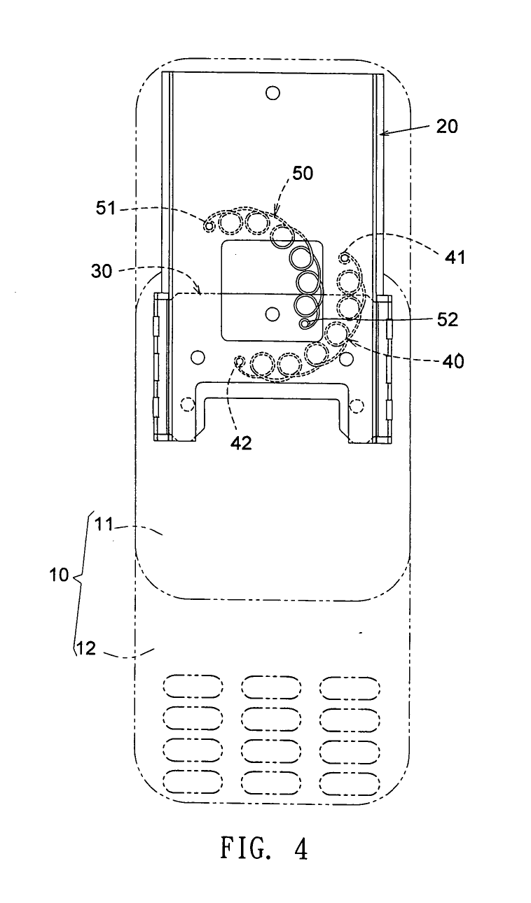

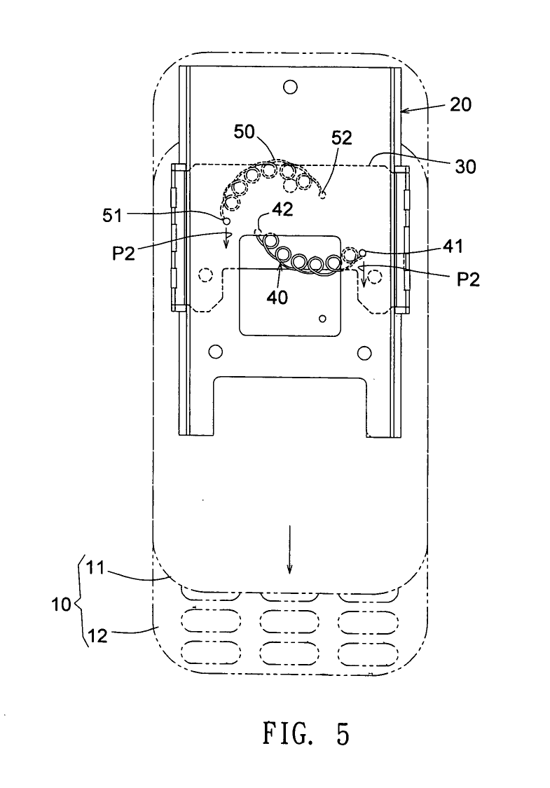

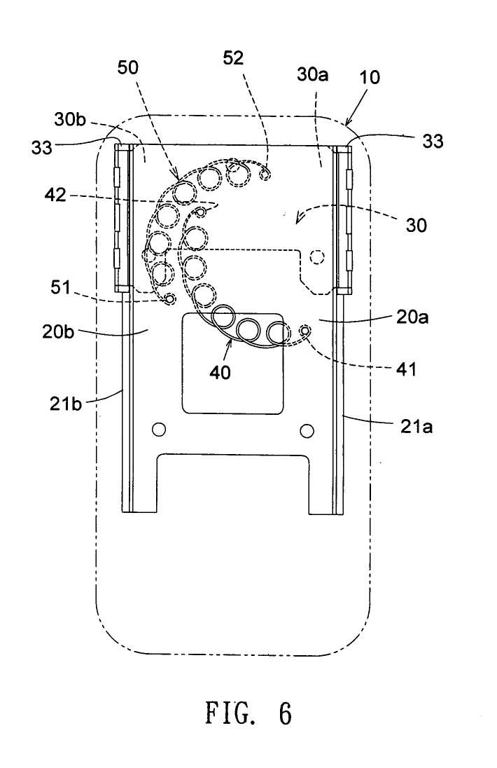

FIG. 4 is a front view showing the sliding mechanism of FIG. 1 in the open position. When the first part 11 of the handheld electronic device 10 is slid toward the second part 12, mechanical energy is stored as the first and second resilient elements 40 and 50 are compressed simultaneously. When the relative locations of the first and second parts 11 and 12 reach what are shown in FIG. 5, the ends 41 and 51 of the first and second resilient elements 40 and 50 attached to the first member 20 are about to pass beneath the ends 42 and 52 attached to the second member 30, respectively. If the first and second members 20 and 30 are closer, the first and second resilient elements 40 and 50 begin to expand and the stored energy is released. As such, from this point on, the first and second members 20 and 30 are automatically slid to the closed position as shown in FIG. 6 entirely by the resilient elements 40 and 50 without any external force. In other words, with the help of the first and second resilient elements 40 and 50, a slight push of the first member 20 or the second member 30, the device 10 would be unfolded automatically into the open position, or collapsed automatically into the closed position.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A sliding mechanism of a handheld electronic device, comprising:
a first member fixedly joined to a first part of said handheld electronic device;
a second member fixedly joined to a second part of said handheld electronic device;
a first resilient element having its two ends fixedly joined to appropriate locations on the inner surfaces of said first and second members respectively; and
a second resilient element having its two ends fixedly joined to appropriate locations on the inner surfaces of said first and second members respectively;
wherein said first and second members are slide-joined together so that they, as well as said first and second parts of said handheld electronic device, are capable of sliding movement along their joining interface relative to each other between an open position and a closed position; and said first and second resilient elements are configured such that said first and second resilient elements do not cross each other during the sliding movement of said first and second members and, during the sliding movement of said first and second members between said closed and open positions, said first and second resilient elements are always compressed first to store energy and then expand automatically as the stored energy is released.

2. The sliding mechanism according to claim 1, wherein the two vertical edges of said first member are bended inward toward its inner surface to form ‘]’ and ‘[’ shapes; the two vertical edges of said second member are bended inward toward its inner surface to form ‘[’ and ‘]’ shapes; and the vertical edges of said second member are wrapped inside the troughs formed by the vertical edges of said first member so that said first and second members are capable to slide relative to each other.

3. The sliding mechanism according to claim 2, wherein a pad element made of a material having low friction coefficient is configured along each of the vertical edges of said second member so that the relatively sliding movement of said first and second members are smoothed.

4. The sliding mechanism according to claim 1, wherein each of said first and second resilient elements is a spring wire wound into a curved segment having multiple consecutive and coplanar loops along the length of said segment.

5. The sliding mechanism according to claim 1, wherein the two ends of each of said first and second resilient elements are screw-joined to the inner surfaces of said first and second members respectively.
